(19) United States
(12) Patent Application Publication
(10) Pub. No.: US 2006/0228539 A1
(43) Pub. Date: Oct. 12, 2006

(54) Construction of gliding board and method of production

(76) Inventor: Kwong Kee Cheung, New Territories (HK)

Correspondence Address: JACOBSON HOLMAN PLLC, 400 SEVENTH STREET N.W., SUITE 600, WASHINGTON, DC, 20004, US

(21) Appl. No.: 11/345,625

(22) Filed: Feb. 2, 2006

Related U.S. Application Data
(63) Continuation-in-part of application No. 11/103,554, filed on Apr. 12, 2005.

(51) Int. Cl. B32B 3/00

(52) U.S. Cl. 428/316.6; 428/319.3; 428/319.7

(57) ABSTRACT

A gliding board, for sliding on waters, snow and land, is constructed from polyethylene foam material, in three-ply or more layers of constant density or different densities as a multi-layer core. The application of compound thermoplastic substance in between each layer of the three-ply board core enhances greater bonding characteristics to lamination of foam materials with different properties.

This is a Continuation-in-Part of U.S. Ser. No. 11/103,554 filed Apr. 12, 2005.

### FIELD OF THE INVENTION

This invention relates to a method of applying compound thermoplastic substances to laminate the core and other layers of a gliding board made from different kinds of foam materials. Particularly, the invention provides an improved bonding characteristic, surface smoothness and efficient manufacture process to a laminated gliding board. The gliding board can be used as a bodyboard, a snow sled, a grass glider, a sand glider or other gliding device for recreational purpose. The unique production method and multi-layers of the board give the advantage of simplification of manufacturing process, minimize the consumption of resources and material production, reducing manufacturing cost, provides a better structure of the board itself together with enhancing its steadfast of the board for providing better safety and comfort performance for end-users.

### BACKGROUND OF THE INVENTION

Generally, a gliding board is composed of a plurality of foam layers laminated together. The sandwich concept is based on two ideas increasing the stiffness in bending of a beam or panel and doing so without adding excessive weight. While the core keeps the skins some distance apart from each other and thereby increasing the stiffness, it also bears most of the shear loading. To perform the sandwich concept correctly, the layers composing the skins and the core of a gliding board must be able to transfer the loads. Without a proper bond, the core and skins of the board work as separate beam and the stiffness is lost. This proves proper core and skins bonding is very critical.

A bodyboard or a snow sled made of a plurality of polyethylene foam layers and polyethylene film layer is typically laminated together by some conventional laminating processes. One conventional process is by heating the layers and the heated surfaces are immediately pressed and fused together by a pair of nip rollers. This laminating process is generally applied for bonding between a polyethylene foam layer to another polyethylene foam layer. Another conventional process of lamination typically applied for bonding between a polyethylene film layer and a polyethylene foam layer is to apply heat to the film with a heated nip roller on the film side and a normal nip roller on the foam side, where the heated nip roller generally contains an engraved pattern of convex and concave area for better heat transfer. The resulting polyethylene film/foam laminate is then often heat laminated onto a standard foam core.

Both of these laminating processes form a bonding between the two layers by localized collapse and fusion of foam cells on the surface of the respective layers. In order to acquire a good bonding between the two layers, the fusion temperature of materials on the surface of the respective layers has to be within a very narrow temperature range. Otherwise inadequate bonding may result because the surface material on one layer has not heat up to the fusion state. If a higher heating temperature is applied to both surfaces of the layers, excessive melting of the surface material on the layer with a lower fusion temperature may occur. Accordingly, there needs to provide a lamination method with improved bonding strength to bond two polymer foam layers with different fusion temperature caused by difference in polymeric material or density.

Gliding devices are usually composed of dual-layer with low density of polymer foam material as board core and essentially having a higher density, closed-cell foam material as intermediate layer for better bonding, by heat laminating between the top and bottom sides of board core and top and bottom skin of the boards. Foam material as board core is normally made from low density elastomers, plastics, or other materials with various porosities. Different categories of foams (for examples, polyethylene, polypropylene, ABS, etc.) will have different characteristics. The differences in density, tensile strength, tensile modulus, elongations, tear strength, use temperature, and thermal conductivity, etc. Foams of different grades and densities will have different properties and characteristics. Thus, for adhering foam to foam physically, heat lamination can be carried out only if the two pieces of foam are of the same grade and density. To adhere two pieces of foam of different grades and densities, lamination can only be carried out by chemical technology—bonding adhesives or a kind of chemical substance as a bridge for the lamination.

Bonding adhesives are basically divided into two categories: physical adhesive and chemical adhesive (hot melt adhesives). Bonding adhesive is the way commonly used in bonding of industrial foam products at large. The advantages of bonding adhesives are that they are simple and effective in processing because hot melt adhesives can be applied under normal temperature. This explains why bonding adhesives are widely used in bonding foam articles. However, bonding adhesives are a kind of material that can be easily and quickly volatiled, and most of them are poisonous and hazardous to the health of human being and natural environment. The object of the present invention is to provide a system for bonding foam layers of different grades and properties together with specific kinds of compound thermoplastic substances. In the course of bonding the compound thermoplastic substance will remain in fusion state and need to be processed or have special treatments according to the grade and property of the foam materials:—
(i) the melting point of the compound thermoplastic substance is particularly low;
(ii) the degree of adhesion is particularly high;
(iii) the flowing degree of the compound thermoplastic is particularly high;
(iv) the degree of expansion of the compound thermoplastic substance is particularly low (the compound thermoplastic substance cannot be condensed at one location but distribute evenly on the surface of core layers).

Came across continuous investigations and trials, the inventor has found a number of compound thermoplastic substances, either from the finished products sold in the market or those investigated by himself, that can be easily and effectively bonding foam layers of a gliding board.

### SUMMARY OF THE INVENTION

It is a principal aspect of the present invention to provide a multi-layer board core of a gliding board constructed by different types of foam materials which will increase the strength characteristics, greater insulation, better impact resistance and stronger resistance to separation.

In a second aspect, the invention features the core of a gliding board is adhered to a pair backing foams, one on the top of the core and one at the bottom of the core, and the upper backing foam is adhered to plastic film by compound thermoplastic substances and the laminate of these layers forms a panty shield achieving a stronger and a more durable structure and to reduce the effects of styrene attack.

In a third aspect, the invention provides a reinforcing side rail or a pair of reinforcing side rails to the side surfaces of a multi-layer board structure in order to enhance the bonding strength of a gliding board and to achieve a quicker, better and more efficient way in the construction and to reduce undesirable wastes.

The invention also allows the use of a variety of foam materials in forming the core and the backing foams of a gliding board. With the application of the compound thermoplastic substances, the invention features a flexible and variable configuration of the core and the backing foam materials of gliding boards in accordance with the purposes and the needs of end-users. The manufacturing process is also simplified by the use of compound thermoplastic substances because manpower to perform trimming works to gliding boards is substantially reduced.

### BRIEF DESCRIPTION OF THE DRAWINGS

FIG. 1 is a perspective view of a first embodiment of the gliding board with polyethylene (PE) foam as the core and ethylene vinyl acetate (EVA) foam as the backing foams.

FIG. 2 is a perspective view of a second embodiment of the gliding board with polystyrene (PS) foam as the core and polyethylene (PE) foam as the backing foams.

FIG. 3 is a perspective view of a third embodiment of the gliding board with polypropylene (PP) foam as the core and polyethylene (PE) foam or ethylene vinyl acetate (EVA) foam as the backing foams.

FIG. 4A is a cross-sectional view of the gliding board deck structure with ethylene vinyl acetate (EVA) foam as the upper backing foam.

FIG. 4B is a cross-sectional view of the gliding board deck structure with polyethylene (PE) foam as the upper backing foam.

FIG. 4C is a cross-sectional view of a gliding board deck structure with polypropylene (PP) foam as the upper backing foam.

FIG. 4D is a cross-sectional view of a gliding board core structure with a reinforcing side rail of polypropylene (PP) foam.

FIG. 4E is a cross-sectional view of a gliding board deck structure with a reinforcing side rail of polyethylene (PE) foam.

FIG. 5A is a cross-sectional view of a gliding board deck structure with ethylene vinyl acetate (EVA) foam as the upper backing foam.

FIG. 5B is a cross-sectional view of a gliding board core structure with a reinforcing side rail of polyethylene (PE) foam.

FIG. 6A is a cross-sectional view of a gliding board deck structure with ethylene vinyl acetate (EVA) foam as the upper backing foam.

FIG. 6B is a cross-section view of a gliding board deck structure with polyethylene (PE) foam as the upper backing foam.

FIG. 6C is a cross-sectional view of a gliding board deck structure with polypropylene (PP) foam as the upper backing foam.

FIG. 6D is a cross-sectional view of a gliding board core structure with a reinforcing side rail of polypropylene (PP) foam.

FIG. 7A is a plan view of a snow sled of the present invention with handles.

FIG. 7B is a plan view of a bodyboard of the present invention.

FIG. 8 is a perspective view of a gliding board of the present invention with a reinforcing side rail.

FIG. 9 is a cross-section view of a gliding board structure of the present invention.

FIG. 10 is a perspective view of a bodyboard of the present invention with a pair of reinforcing side rails and a rear side rail.

FIG. 11 is a side, cross-sectional, longitudinal view of a gliding board structure of the present invention.

FIG. 12 is a partially schematic view of the new methodology of viscose of a deck of the present invention.

### DETAILED DESCRIPTION OF THE PREFERRED EMBODIMENTS

While the invention will be described in connection with certain preferred embodiments, i.e. bonding foam layers of different densities and properties together with compound thermoplastic substances, it is to be understood that the present invention is not to be limited to the use of one particular kind of compound thermoplastic substance. For example, the compound thermoplastic substance may be varied in accordance with the grades, properties and densities of foam materials composed of the structure of a gliding board. Further, the present invention is not limited to the particular configuration of the gliding boards shown in the figures and may be of any configuration as is known in the art.

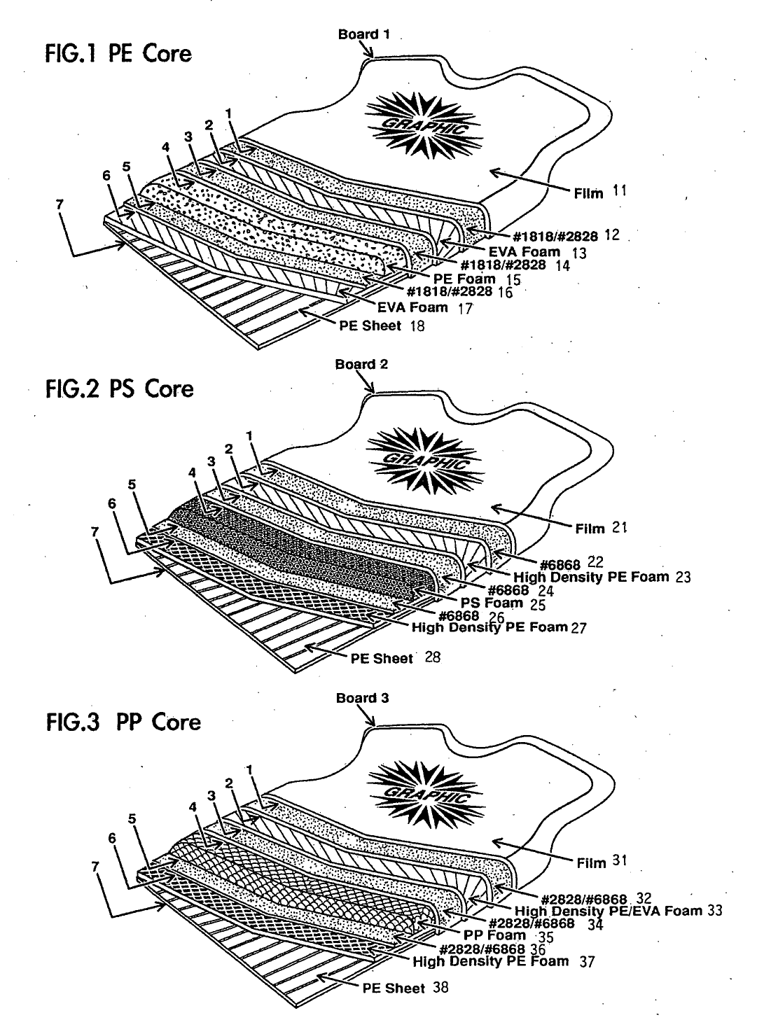

FIG. 1 illustrates a perspective view of a first embodiment of the present invention of a gliding board. This gliding board has eight layers in the configuration wherein three layers of the compound thermoplastic substances are applied alternately for bonding the core 25 of polystyrene foam, the deck and the bottom skin, laminated together.

Top layer 11 is a graphically-imprinted plastic polymer film. Graphic images are reversely imprinted on the inner surface of layer 11 using any conventional process for printing on polyethylene or polypropylene, such as the corona printing process, in which an electrical discharge temporarily alters the surface structure of the film, allowing inks to adhere to the film. The top surface plastic polymer film 11 has a thickness in the range of 0.02 to 0.15 mm.

Layer 12 is the first layer of the compound thermoplastic substance (#1818 or #2828) wherein substance #1818 includes low density polyethylene, ethylene vinyl acetate and tackifying resin, and substance #2828 includes Metallocen Catalysced resin and polyethylene. Layer 12 has a thickness in the range of 0.02 to 0.10 mm.

Layer 13 is the upper backing foam of closed-cell, high density foam of ethylene vinyl acetate. The upper backing foam 13 has a thickness in the range of 1 to 5 mm, and has a stiffness of between 25 and 65 degrees, and preferably 45 degrees.

Layer 14 is the second layer of the compound thermoplastic substance (#1818/#2828). Layer 14 is to be coated onto the inner surface of the upper backing foam 13 after a deck (Layers 11, 12 and 13 are bonded together) is formed. Layer 14 has a thickness in the range of 0.02 to 0.10 mm.

Layer 15 is the core of a gliding board of low density polyethylene foam material. The core 15 has a thickness in the range of 26 to 51 mm and has a density in the range of 1.5 to 4 lb/ft³, and preferably a density of 2.2 lb/ft³.

Layer 16 is the third layer of the compound thermoplastic substance (#1818/#2828). Layer 16 is coated onto the outer surface of the lower backing foam 17 after the bottom skin (layers 17 and 18 are bonded together) is formed. Layer 16 has a thickness in the range of 0.02 to 0.10 mm.

Layer 17 is the lower backing foam of closed-cell, high density foam of ethylene vinyl acetate. The lower backing foam 15 has a thickness in the range of 1 to 5 mm, and has a stiffness of between 25 and 65 degrees, and preferably 45 degrees.

Layer 18 is a bottom protective sheet of polyethylene foam material. Layer 16 has a thickness in the range of 0.04 to 2 mm.

Adopting the first layer of the compound thermoplastic substance (#1818/#2828) 12 for agglutination with the plastic polymer graphic film 11 to the upper backing foam 13 of high density ethylene vinyl acetate foam material. A heat lamination method is used for bonding layers 11, 12 and 13 together forming the deck of a gliding board. Again, a heat lamination is used for bonding the lower backing foam 17 and the bottom protective sheet 18 together forming the bottom skin of a gliding. To bond the core 15, the deck and the bottom skin together, the second layer and the third layer of the compound thermoplastic substances 14, 16 are coated onto the inner surface of layer 13 and the outer surface of layer 17 respectively before a heat lamination is used for bonding the three spheres. The plastic polymer graphic film 11 extends from the top portion to the polyethylene sheet at the bottom to form the gliding board.

FIG. 2 shows a perspective view of a second embodiment of the present invention of a gliding board. The core 25 of this gliding board is made from low density polystyrene foam material and it is sandwiched by a pair of backing foams 23, 27 of high density polyethylene foam material. Adopting the first layer of the compound thermoplastic substance (#6868/#1818/#2828) 22 for agglutination with the plastic polymer graphic film 21 to the upper backing foam 23. Compound thermoplastic substance #6868 includes anhydride-modified ethylene vinyl acetate polymers, substance #1818 includes ethylene vinyl acetate, tow density polyethylene and tackifying resin, substance #2828 includes Metallocen Catalysced resin. Layer 22 lays in between layers 21 and 23. Layer 22 can fill in the gaps between the peaks and valleys of layer 23 to have intimate contact and better bonding. A heat lamination is used for bonding layers 21, 22 and 23 forming the deck of a gliding board. Thereafter, a heat lamination is used for bonding layers 27 and 28 together forming the bottom skin of a gliding board. The second layer of the compound thermoplastic substance (#6868) 24 is coated onto the inner surface of the upper backing foam 23 and the third layer of the compound thermoplastic substance (#6868) 26 is coated onto the outer surface of the lower backing foam 27, for agglutination with the core 25 of low density polystyrene foam material. A heat lamination method is thereafter used for bonding the core 25 with the deck and the bottom skin, and the plastic polymer graphic film 21 extends from the top portion to the polyethylene sheet 28 at the bottom to form the gliding board.

FIG. 3 shows a perspective view of a third embodiment of the present invention of a gliding board. The construction of the gliding board in FIG. 3 is similar to the construction in FIG. 2, except that the combination of the core and the backing foams are of different foam materials. The upper backing foam 33 in this preferred embodiment may be polyethylene or ethylene vinyl acetate. The core 35 is a low density polypropylene foam material. A second and a third layer of the compound thermoplastic substances 34, 36, Which have sandwiched the core 35, may be substance #2828 or #6868.

For the bond to work correctly, the density of the compound thermoplastic substance ought to be stronger than the foam material it is joining. The essential part of adhering foam to foam, or foam to plastic polymer film, is to fill the surface cells with the adhesive and protection against water intrusion. The serial numbers of the compound thermoplastic substances, namely, #1818, #2828, #6868 and #7878 (which includes anhydride-modified ethylene vinyl acetate polymers, ethylene vinyl acetate and tackifying resin), are assigned by the inventor by reference to the ingredients and specific prescriptions of each of the substances. Each particular compound thermoplastic substance is applied in accordance with the type, density and property of the foam materials that is constituted as the core of the gliding board.

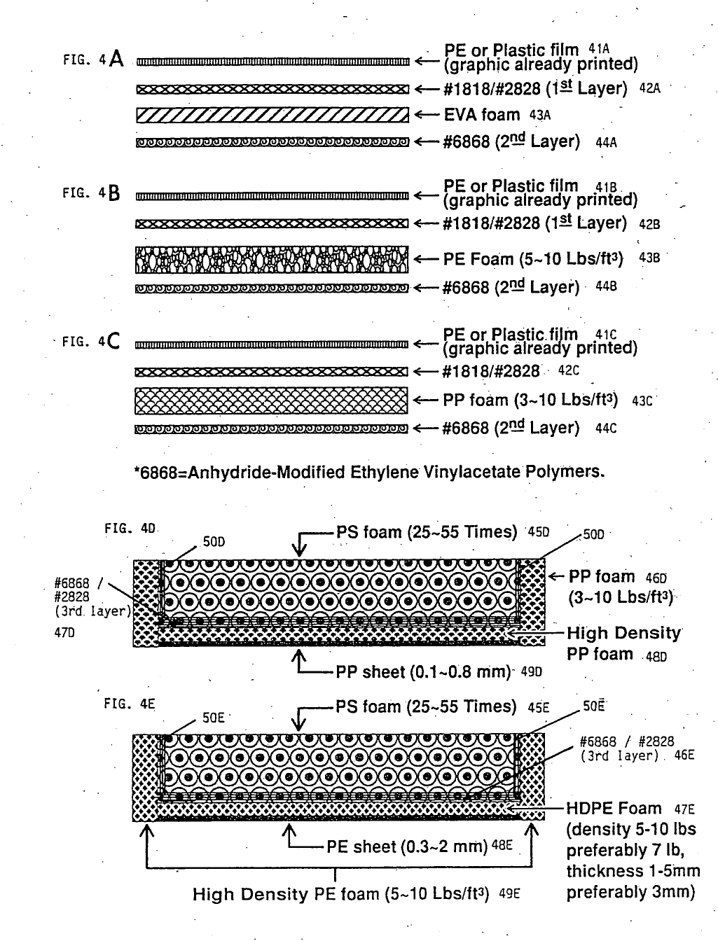

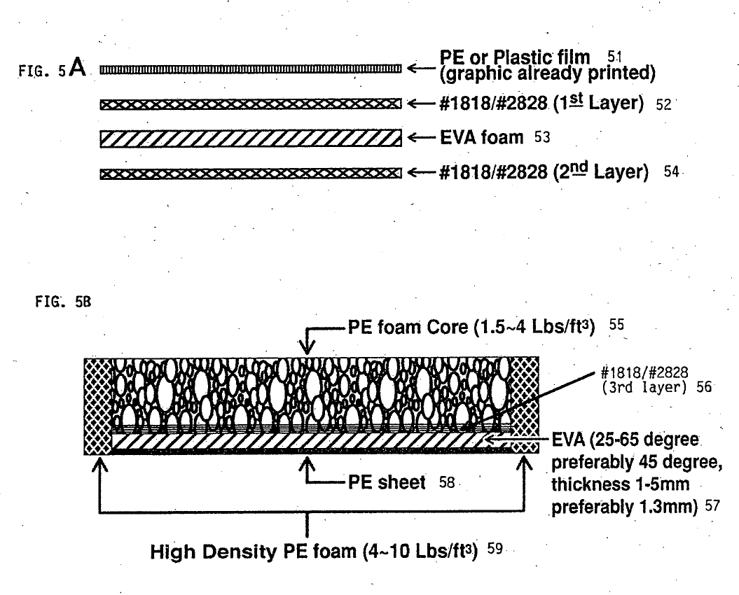

FIG. 4A shows a cross-sectional view of the deck structure of the present invention of a gliding board. To bond the top surface plastic polymer film 41A with the upper backing foam 43A, a first layer of the compound thermoplastic substance (#1818/#2828) 42A is applied to the outer surface of the upper backing foam 43A for agglutination. The upper backing foam 43A is made from a high density, closed-cell ethylene vinyl acetate foam material having a thickness of between 1 and 5 mm, and preferably a thickness of 1.3 mm. The upper backing foam 43A has a stiffness ranging from 25 degrees to 65 degrees, and preferably a stiffness of 45 degrees. A second layer of the compound thermoplastic substance (#6868) 44A is to be coated onto the inner surface of layer 43A for agglutination with the core 45D or 45E of a gliding board.

FIG. 4B shows a similar cross-sectional view of the deck structure of the present invention of a gliding board as at FIG. 4A, but in which a high density polyethylene foam material is adopted as the upper backing foam 43B. By agglutination of a first layer of the compound thermoplastic substance (#1818 or #2828) 42B onto the outer surface of the upper backing foam 43B and by heat lamination, the plastic polymer film 41B is ready to be bonded with the upper backing foam 43B forming the deck of a gliding board. Layer 43B has a thickness in the range of 1 to 5 mm and has a density in the range of 5 to 10 lb/ft³, and preferably a density of 7 lb/ft³.

FIG. 4C shows a similar cross-sectional view of the deck structure of the present invention of a gliding board as at FIG. 4A, except that the upper backing foam 43C is a high density polypropylene foam material. Bonding the plastic polymer graphic film 41C and the upper backing foam 43C together, with the application of the first layer of the compound thermoplastic substance (#1818 or #2828) 42C, by heat lamination, a deck is then formed. The second layer of the compound thermoplastic substance (#6868) to thereafter coated onto the inner surface of the deck and ready to be bonded with the core 45D or 45E. The upper backing foam 43C has a thickness in the range of 1 to 5 mm, and preferably a thickness of 3 mm. The upper backing foam 43C has a density in the range of 3 and 10 lb/ft³, and preferably a density of 7 lb/ft³.

FIG. 4D illustrates a cross-sectional view of the core and bottom skin structure of the present invention of a gliding board. The core of the gliding board 45D consists of a low density of polystyrene foam material. The core 45D has a thick thickness of between 26 and 51 mm. To adhere the core 45D and the lower backing foam 48D of different densities and properties, a third layer of compound thermoplastic substance (#2828 or #6868) 47D is coated onto the outer surface of the lower backing foam 48D for agglutination. The bottom protective sheet of high density polypropylene foam 49D is bonded to the bottom surface of the lower backing foam 48D by heat lamination forming the bottom skin of a gliding board. The reinforcing side rail 46D, which covers the side surfaces of the core 45D, the lower backing foam 48D and the bottom protective sheet 49D, of this preferred embodiment is made from a high density polypropylene foam material. To secure a good bonding between the reinforcing side rail 46D and the side surfaces of the core 45D of different foam materials by heat lamination, a layer of the compound thermoplastic substance (#6868/#2828) 50D is adopted and coated onto the inside surface of the reinforcing side rail. The bottom protective sheet 49D has a thickness of between 0.1 to 0.8 mm. The reinforcing side rail 46D has a density in the range of 3 to 10 lb/ft³.

FIG. 4E illustrates a similar cross-sectional view of the core and bottom skin structure of the present invention of a gliding board as at FIG. 4D, except that the lower backing foam 47E and the reinforcing side rail 49E are both made from high density polyethylene foam material. The bottom protective sheet 48E in this preferred embodiment is made from polyethylene foam material and has a thickness of between 0.3 to 2 mm. To adhere the core 45E and the lower backing foam 47E of different grades and properties, a third layer of the compound thermoplastic substance (#2828/#6868) 46E is coated onto the outer surface of the lower backing foam 47E for agglutination. To bond the reinforcing side rail 49E of high density polyethylene foam material with the core 45E of polystyrene foam by heat lamination, a layer of the compound thermoplastic substance (#6868/#2828) is adopted and coated onto the inside surface of the reinforcing side rail. The reinforcing side rail 49E has a density in the range of 5 to 10 lb/ft³.

The deck structures of the gliding board as shown in FIGS. 4A, 4B and 4C are that each can be freely combined with the core and bottom skin structures of the gliding board as shown in FIG. 4D or 4E.

FIG. 5A shows a similar cross-sectional view of deck structure of the present invention of a gliding board as at FIG. 4A, except that the second layer of the compound thermoplastic substance 54 is substance #1818/#2828. The application of a different kind of the compound thermoplastic substance is that the core of this preferred embodiment is low density polyethylene foam. Compound thermoplastic substance #1818 includes low density polyethylene tackifying resin and ethylene vinyl acetate copolymer and substance #2828 is Metallocen Catalysced resin.

FIG. 5B is another cross-sectional view of the core and bottom skin structure of the present invention of a gliding board. The core 55 of this preferred embodiment is made from low density of polyethylene foam material. The core 55 has a density in the range of 1.5 to 4 lb/ft³ and has a thickness of approximately 26 to 51 mm. The lower backing foam 57 is made from high density ethylene vinyl acetate foam material having a thickness of between 1 and 5 mm, and preferably a thickness of 1.3 mm. Before adhering to the core, a heat lamination is used for bonding the lower backing foam 57 and the bottom polyethylene sheet 58. Thereafter, to bond the core 55 of low density polyethylene foam with the bottom skin (layer 57 and 58 bonded together), a third layer of compound thermoplastic substance (#1818 or #2828) is applied and coated onto the outer surface of lower backing foam 57 as the agent for agglutination. The reinforcing side rail 59 is made from high density polyethylene foam material and has a density in the range of 4 to 10 lb/ft³, and preferably a density of 6 lb/ft³. Whilst the core 55 and the reinforcing side rail 59 are both made from polyethylene foam material, a heat lamination is used for bonding the reinforcing side rail to the side surface of the core without the need of a compound thermoplastic substance.

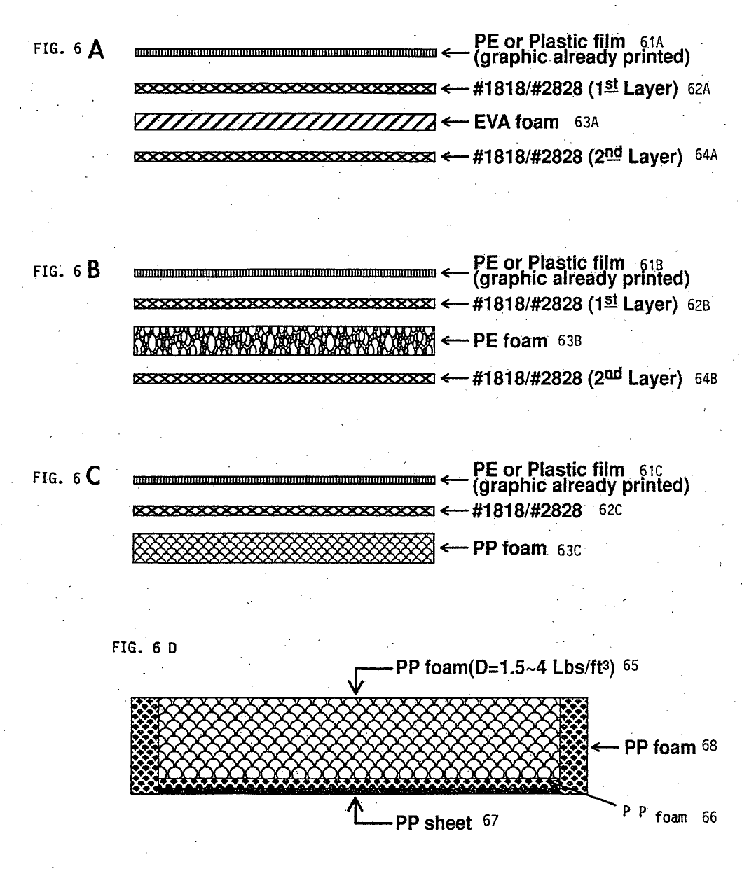

FIG. 6A shows a similar cross-sectional view of the deck structure of the present invention of a gliding board as at FIG. 5A.

FIG. 6B shows a similar cross-sectional view of the deck structure of the present invention of a gliding board as at FIG. 4B, except that a second layer of the compound thermoplastic substance (#1818/#2828) 64B is adopted for adhering the core 65 of the gliding board.

FIG. 6C shows a similar cross-sectional view of the deck structure of the present invention of a gliding board as at FIG. 4C, except that a second layer of the compound thermoplastic substance is not required for adhering the core 65 of the gliding board.

FIG. 6D shows a cross-sectional view of the core and bottom skin structure of the present invention of a gliding board. The core 65 in this preferred embodiment is made from a polypropylene foam material and has a density of between 1.5 to 4 lb/ft³. Whilst the lower backing foam 66 is also made from a polypropylene foam material, no compound thermoplastic substance is required for adhering the core 65 and the lower backing foam 66. A heat lamination method is used for bonding the bottom protective sheet 67 of polypropylene foam, the lower backing foam 66 and the core 65. The reinforcing side rail 68 is made from high density polypropylene foam material and has a density in the range of 3 to 10 lb/ft³. The reinforcing side rail 68 is bonded to the side surfaces of the core 65, the tower backing foam 66 and the bottom protective sheet 67 by heat lamination.

FIGS. 4A to 6D illustrate some of the combinations of the configuration of the present invention of a gliding board but the combinations of the deck, core and bottom skin structure of the present invention are not limited to those illustrated in the foregoing figures.

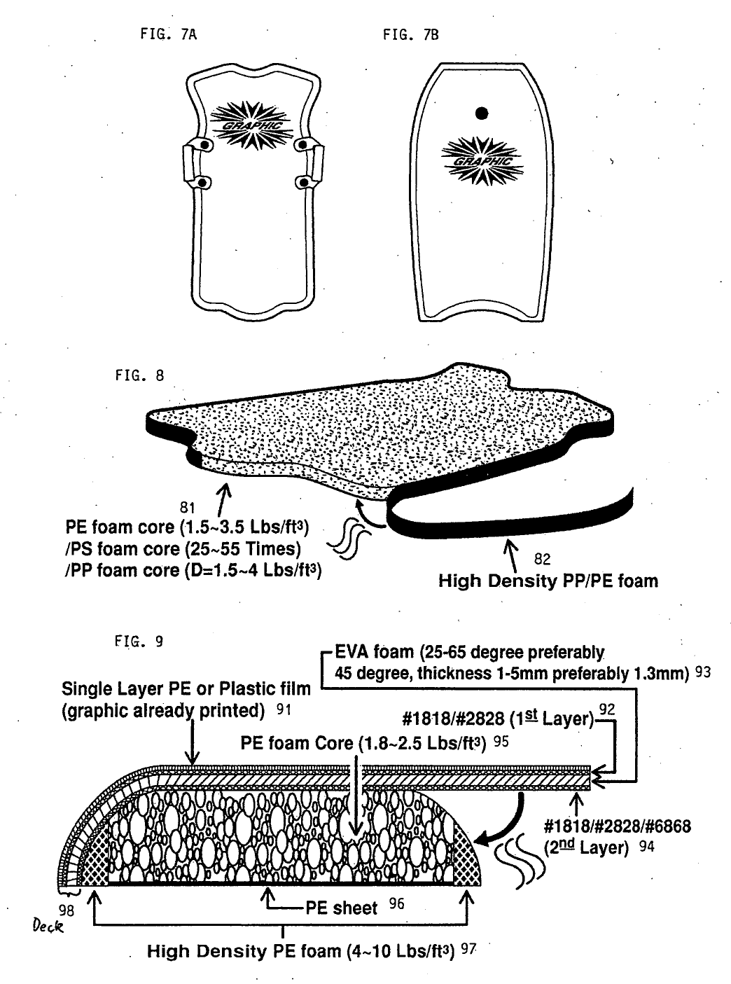

FIGS. 7A and 7B are the plan views of a slow sled and a bodyboard of different designs.

FIG. 8 is a perspective view of a core structure of the present invention in which a reinforcing side rail 82 of high density polypropylene or polyethylene foam material is adopted surrounding the side surface of the core 81. The core 81 of this preferred embodiment may be tow density polyethylene, polystyrene or polyethylene foam materials. If the core is made from low density polyethylene foam material, the density of the core is approximately 1.8 to 2.5 lb/ft³. If the core is made from low density polystyrene foam material, the density of the core is approximately 22 to 25 times. If the core is made from low density polypropylene foam material, the density of the core is approximately 1.5 to 4 lb/ft³.

FIG. 9 is a cross-sectional view of another preferred embodiment of the present invention in which the core 94 of the gliding board is made from tow density polyethylene and having a density of approximately 1.8 to 2.5 lb/ft³. The core 94 is strengthened by a reinforcing side rail 97 of high density polyethylene foam material having a density in the range between 4 and 10 lb/ft³. The deck 98 consists of the plastic graphic film 91, the first layer of the compound thermoplastic substance (#1818/#2828) 92 and the upper backing foam 93 of ethylene vinyl acetate having a thickness of 1 to 5 mm and a density of 25 to 65 degrees. The bottom surface of the deck 98 is coated with the second layer of the compound thermoplastic substance (#1818/#2828/#6868) 94 as the agent for agglutination between the deck 98 and the core 95. The surface of the core 95 and the reinforcing side rail 97 will be completely covered by the deck 98 after they are bonded together.

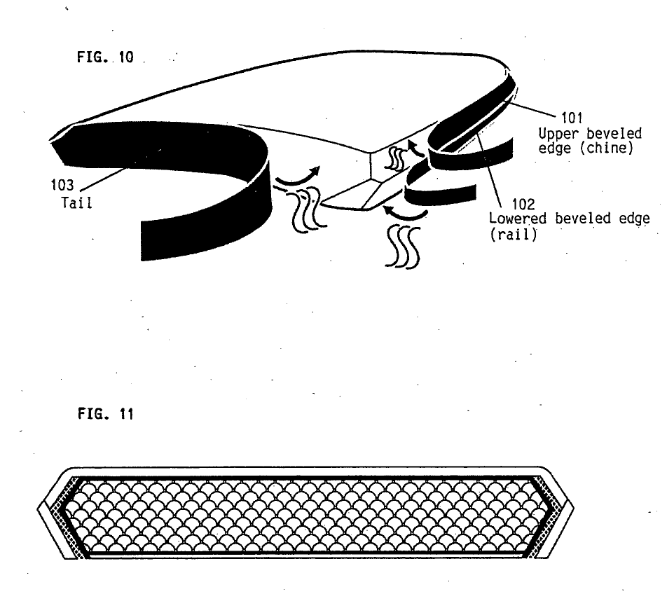

FIG. 10 illustrates a perspective view of another preferred embodiment of the present invention of a bodyboard. The reinforcing side rail covering the side surfaces of the core is divided into two parts, an upper beveled edge (a chine) 101 and a lowered beveled edge (a rail) 102, and the side edge at the tail of the board core is covered by a reinforcing side rail at tail 103.

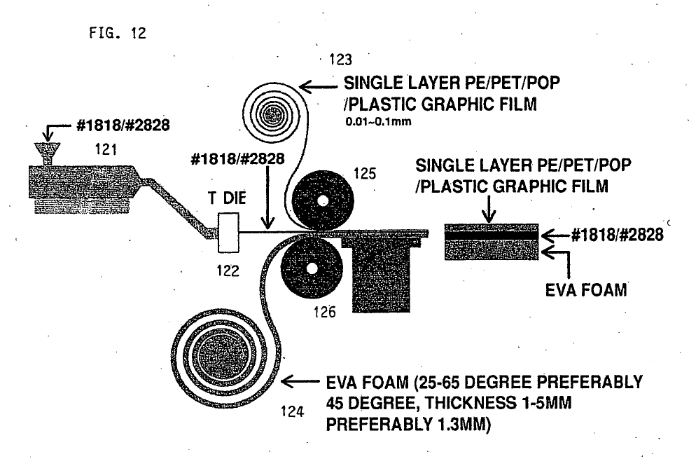

FIG. 11 shows a cross-sectional view of a preferred embodiment of FIG. 10.

FIG. 12 illustrates a partial schematic view of the new method of bonding of plastic polymer graphic film 123 to the upper backing foam 124 of the present invention. By shoving the compound thermoplastic substance which contains ethylene vinyl acetate copolymer and tackifying resin (#1818) or Metallocen Catalysced resin (#2828) in the furnace 121 with a high temperature of 180 to 200 degrees, and thereafter passing through a T-die 122 for injection, a layer of compound thermoplastic substance is placed in between the plastic graphic film 123 and the upper backing foam 124 which are both in roll format to be bonded and pressurized by an upper embossing roller (or plain roller) 125 and a lower plain roller 126 for reinforcement of the stiffness of the graphic film to the board core.

What is claimed is:

1. A gliding board with reinforcing bonding characteristics to a multi-layer structure comprising:
a foam board having a top surface, a bottom surface, side surfaces and front and back surfaces;
a top plastic polymer film with graphic imprinted;
a first layer of the compound thermoplastic substance;
an upper backing foam;
a second layer of the compound thermoplastic substance;
a core located between an upper backing foam and a lower backing foam;
a third layer of compound thermoplastic substance;
a lower backing foam;
a bottom protective sheet; and
a reinforcing side rail or a pair of reinforcing side rails and a rail at tail.

2. The gliding board as claimed in claim 1, wherein said top plastic polymer graphic film comprising:
an inner surface having a graphic image reversely imprinted thereon and an outer surface;
said outer surface is non-opaque;
a selected from polyethylene and polypropylene and the film has a thickness of between 0.02 to 0.15 mm; and
said inner surface is bonded to the outer surface of the upper backing foam.

3. The gliding board as claimed in claim 1, wherein said upper backing foam comprising:—
a high density foam of polyethylene or ethylene vinyl acetate or polypropylene having an outer surface and an inner surface;
a high density foam of polyethylene having a density in the range of 5 to 10 lb/ft³ and having a thickness of 1 to 5 mm;
a high density foam of ethylene vinyl acetate having a density in the range of 26 to 65 degrees, and preferably 45 degrees and having a thickness of 1 to 5 mm; and
a high density foam of polypropylene having a density in the range of 3 to 10 lb/ft³ and having a thickness of 1 to 5 mm.

4. The gliding board as claimed in claim 3, wherein the outer surface of said upper backing foam is laminated to the inner surface of said top surface polymer graphic film with the application of a first layer of the compound thermoplastic substance for agglutination.

5. The gliding board as claimed in claim 4, wherein said first layer of the compound thermoplastic substance may be thermoplastic substance #1818 comprising low density polyethylene, ethylene vinyl acetate and tackifying resin, or thermoplastic substance #2828 comprising Metallocen Catalysced resin and polyethylene, or thermoplastic substance #6868 comprising anhydride-modified ethylene vinyl acetate polymers, or thermoplastic substance #7878 comprising anhydride-modified ethylene vinyl acetate polymers, ethylene vinyl acetate and tackifying resin, and having a thickness of approximately 0.02 to 0.10 mil.

6. The gliding board as claimed in claim 1, wherein said core comprising:—
a layer of low density foam of polyethylene or polystyrene or polypropylene having an outer surface and an inner surface;
a layer of low density foam of polyethylene having a thickness of approximately 26 to 51 mm and having a density of approximately 1.5 to 3.5 lb/ft³;
a layer of low density foam of polystyrene having a thickness of approximately 26 to 51 mm and having a density of approximately 25 to 55 times PCI; and
a layer of low density foam of polypropylene having a thickness of approximately 26 to 51 mm and having a density of approximately 1.5 to 4 lb/ft³.

7. The gliding board as claimed in claim 6, wherein the outer surface of said core of low density foam is laminated to the inner surface of said upper backing foam with the application of a second layer of the compound thermoplastic substance as a bridge for agglutination.

8. The gliding board as claimed in claim 7, wherein said second layer of the compound thermoplastic substance is coated onto the inner surface of the upper backing foam and the compound thermoplastic substance may be substance #1818 comprising low density polyethylene, ethylene vinyl acetate and tackifying resin, or thermoplastic substance #2828 comprising Metallocen Catalysced resin and polyethylene, or thermoplastic substance #6868 comprising anhydride-modified ethylene vinyl acetate polymers, or thermoplastic substance #7878 comprising anhydride-modified ethylene vinyl acetate polymers, ethylene vinyl acetate and tackifying resin, having a thickness of approximately 0.02 to 0.10 mils.

9. The gliding board as claimed in claim 1, wherein said lower backing foam comprising:
a high density foam of polyethylene or ethylene vinyl acetate or polypropylene having an outer surface and an inner surface;
a high density foam of polyethylene having a density in the range of 5 to 10 lb/ft³ and having a thickness of 1 to 5 mm;
a high density foam of ethylene vinyl acetate having a density in the range of 26 to 65 degrees, and preferably 45 degrees and having a thickness of 1 to 5 mm; and
a high density foam of polypropylene having a density in the range of 3 to 10 lb/ft³ and having a thickness of 1 to 5 mm.

10. The gliding board as claimed in claim 9, wherein the inner surface of said core is laminated to the outer surface of said lower backing foam of high density foam of polyethylene or ethylene vinyl acetate with the application of a third layer of the compound thermoplastic substance for agglutination.

11. The gliding board as claimed in claim 10, wherein said third layer of the compound thermoplastic substance is coated onto the outer surface of said lower backing foam and the compound thermoplastic substance may be substance #1818 comprising low density polyethylene, ethylene vinyl acetate and tackifying resin, or thermoplastic substance #2828 comprising Metallocen Catalysced resin and polyethylene, or thermoplastic substance #6868 comprising anhydride-modified ethylene vinyl acetate polymers, or #7878 comprising anhydride-modified ethylene vinyl acetate polymers, ethylene vinyl acetate and tackifying resin, having a thickness of approximately 0.02 to 0.10 mm.

12. The gliding board as claimed in claim 1, wherein said bottom protective sheet comprising:
a layer of polyethylene or polypropylene sheet having an inner surface and a bottom surface;
a layer of polyethylene sheet having a thickness of approximately 0.3 to 2 mm.
a layer of polypropylene sheet having a thickness of approximately 0.1 to 0.8 mm.

13. The gliding board as claimed in claim 12, wherein the inner surface of said lower backing foam is bonded with the outer surface of said bottom protective sheet by heat lamination.

14. The gliding board as claimed in claim 1, wherein a reinforcing side rail comprising:
a layer of high density foam of polyethylene or polypropylene sheet having an inside surface and an outside surface;
a layer of high density foam of polyethylene or polypropylene sheet having a thickness of approximately 0.2 to 2 mm;
a layer of high density foam of polyethylene sheet having a density of approximately 5 to 10 lbs/ft³;
a layer of closed-cell foam of polypropylene sheet having a density of approximately 3 to 10 lbs/ft³; and
said inside surface is bonded to the side surfaces of said core, said lower backing foam and said bottom protective sheet.

15. The gliding board as claimed in claim 1, wherein said reinforcing side rail, in the case of a bodyboard, comprising:
a pair of side rails and a rear side rail each having an inside surface and an outside surface;
said pair of side rails comprising an upper side rail and a lower side rail;
said pair of side rails and said rear side rail are a closed-cell, high density foam of polyethylene or polypropylene;
said pair of side rails and said rear side rail is made from a closed-cell, high density foam of polyethylene, each having a thickness of approximately 0.2 to 2 mm and each having a density of 5 to 10 lbs/ft³; and
said pair of side rails and said rear side rail is made from a closed-cell, high density foam of polypropylene, each having a thickness of approximately 0.2 to 2 mm and each having a density of 3 to 10 lbs/ft³.

16. The gliding board as claimed in claim 15, wherein the inside surfaces of said upper side rail and said lower side rail are bonded to the side surfaces of said core, said lower backing foam and said bottom protective sheet, and the inside surface of said rear side rail is bonded to the side surface of the tail of the gliding board.

17. The gliding board as claimed in claim 1, wherein a thickness of said core is approximately 26 to 51 mm.

18. The gliding board as claimed in claim 1, wherein a density of said core is approximately 1.5 to 4 lb/ft³.

19. The gliding board as claimed in claim 1, wherein said bottom protective sheet has a thickness of approximately 0.1 to 2 mm.

20. The gliding board as claimed in claim 1, wherein a lamination between a bottom protective sheet with a lower backing foam is achieved by heat lamination.

21. The gliding board as claimed in claim 1, wherein said top surface plastic polymer graphic film extends to attach to the bottom protective backing sheet.

22. A method of producing a gliding board, said method comprising:
(A) agglutinating an upper backing foam of high density polyethylene or ethylene vinyl acetate or polypropylene with a layer of plastic polymer graphic film by a first layer of compound thermoplastic substance under the temperature of 180 to 200 degrees;
(B) applying a second layer of the compound thermoplastic substance in manner of coating onto the inner surface of the upper backing foam for agglutination with the core, and a thickness of the second layer of the compound thermoplastic substance is approximately 0.02 to 0.10 mm;
(C) applying heat and pressure to bond a lower backing foam with a bottom protective sheet to form a bottom skin of the gliding board;
(D) applying a third layer of the compound thermoplastic substance in manner of coating onto the outer surface of the lower backing foam for agglutination with the core, and a thickness of the third layer of the compound thermoplastic substance is approximately 0.02 to 0.10 mm;
(E) applying heat and pressure to bond the deck, the core and the bottom skin to form a semi-finished gliding board;
(F) applying heat and pressure to bond the reinforcing side rail or a pair of side rails and a rear side rail to the side surfaces of the core, lower backing foam, bottom protective sheet and tail of the gliding board if the foam materials of the core and side rail are of the same property;
(G) applying a layer of the compound thermoplastic substance in manner of coating onto the inside surface of the reinforcing side rail, and applying heat and pressure to bond the side rail or a pair of side rails and a rear side rail to the side surfaces of the core, lower backing foam, bottom protective sheet and tail of the gliding board if the foam materials of the core and side rail are not the same property; and
(H) applying heat and pressure to extend the top plastic polymer graphic film to attach to a bottom protective sheet secured to form the gliding board.

23. The method as claimed in claim 22, wherein a thickness of the plastic polymer graphic film is approximately 0.02 to 0.15 mm.

24. The method as claimed in claim 22, wherein a thickness of the upper backing foam is approximately 1 to 5 mils.

25. The method as claimed in claim 22, wherein a thickness of the core is approximately 26 to 51 mm.

26. The method as claimed in claim 22, wherein a thickness of the lower backing foam is approximately 1 to 5 mils.

27. The method as claimed in claim 22, wherein a thickness of the bottom protective sheet is approximately 0.1 to 2 mm.

28. The method as claimed in claim 22, wherein a thickness of the first layer of the compound thermoplastic substance is approximately 0.02 to 0.10 mm.

29. The method as claimed in claim 22, wherein a thickness of the second layer of the compound thermoplastic substance is approximately 0.02 to 0.10 mm.

30. The method as claimed in claim 22, wherein a thickness of the third layer of the compound thermoplastic substance is approximately 0.02 to 0.10 mm.

31. The method as claimed in claim 22, wherein a thickness of the side rail is approximately 1 to 7 mm.
